(19) United States
(12) Patent Application Publication
(10) Pub. No.: US 2026/0030346 A1
(43) Pub. Date: Jan. 29, 2026

(54) Autonomous Cyber-Security Investigation and Response using Graphs

(71) Applicant: Palo Alto Networks (Israel Analytics) Ltd., Tel Aviv (IL)

(72) Inventors: Erez Levy, Ganei Tikva (IL); Yuval Zan, Givatayim (IL); Chen Erlich, Beer Yaakov (IL); Netanel Rimer, Givatayim (IL)

(21) Appl. No.: 18/783,523

(22) Filed: Jul. 25, 2024

(51) Int. Cl. G06F 21/55; G06F 21/56

(52) U.S. Cl. CPC G06F 21/552; G06F 21/566; G06F 2221/034

(57) ABSTRACT

A system for autonomous cyber-security investigation includes an input interface and one or more processors. The input interface receives security-related inputs detected in a computer system. The processors construct, based on the security-related inputs, a graph including nodes and edges. The nodes include (i) appearance-nodes representing occurrences in the computer system having respective times-of-occurrence and (ii) artifact-nodes representing time-static features found in the security-related inputs. The edges represent relationships between the nodes. The processors select a trigger node that serves as an initial trigger for a given cyber-security investigation, perform an iterative process that generates a sub-graph of the graph that is specific to the given cyber-security investigation, by iteratively (i) enriching the graph with additional information and (ii) expanding the sub-graph with additional nodes from the graph in response to the additional information, and decide on a result of the given cyber-security investigation based on the sub-graph.

### FIELD OF THE INVENTION

The present invention relates generally to cyber-security, and particularly to methods and systems for autonomous cyber-security investigation and response.

### BACKGROUND OF THE INVENTION

Protection against security hazards in a computer system typically involves detecting incidents occurring in the system, distinguishing between malicious and benign occurrences, and acting upon the occurrences regarded as malicious. In practice, the number of security-related inputs that need to be processed is extremely large, and the relationships between them are complex. As such, it is virtually impossible for human analysts or Security Operations Center (SOC) operators to investigate such occurrences thoroughly and reach quality results.

### SUMMARY OF THE INVENTION

An embodiment of the present invention that is described herein provides a system for autonomous cyber-security investigation including an input interface and one or more processors. The input interface is configured to receive security-related inputs detected in a computer system. The one or more processors are configured to construct, based on the security-related inputs, a graph including nodes and edges. The nodes include (i) one or more appearance-nodes representing occurrences in the computer system having respective times-of-occurrence and (ii) one or more artifact-nodes representing time-static features found in the security-related inputs. The edges represent relationships between the nodes. The one or more processors are configured to select in the graph a trigger node that serves as an initial trigger for a given cyber-security investigation, to perform an iterative process that generates a sub-graph of the graph that is specific to the given cyber-security investigation, by iteratively (i) enriching the graph with additional information and (ii) expanding the sub-graph with one or more additional nodes from the graph in response to the additional information, and to decide on a result of the given cyber-security investigation based on the sub-graph.

In an embodiment, the one or more processors are further configured to initiate a responsive action based on the result of the given cyber-security investigation. In a disclosed embodiment, the one or more processors are configured to enrich the graph by fetching at least part of the additional information from the computer system.

In some embodiments, the one or more processors are configured to iteratively expand the sub-graph, starting from the trigger node, until failing to find additional nodes whose distance from the trigger node is below one or more defined cut-off distances. In a disclosed embodiment, the one or more processors are configured to assign respective significance scores to the nodes, and to calculate the distance between a candidate node and the trigger node responsively to the relevance scores of one or more nodes that lie along a shortest path through the graph between the candidate node and the trigger node.

In another embodiment, the one or more processors are configured to enrich the graph in accordance with a predefined bank of enrichment rules. In yet another embodiment, the one or more processors are configured to decide on the result of the given cyber-security investigation by running multiple attack detection modules, each attack detection module associated with a respective type of malicious attack. In an example embodiment, a given attack detection module is configured to calculate for the sub-graph a maliciousness score indicative of a likelihood that the sub-graph represents a malicious attack of the respective type.

There is additionally provided, in accordance with an embodiment of the present invention, a method for autonomous cyber-security investigation. The method includes receiving security-related inputs detected in a computer system. A graph including nodes and edges is constructed based on the security-related inputs. The nodes include (i) one or more appearance-nodes representing occurrences in the computer system having respective times-of-occurrence and (ii) one or more artifact-nodes representing time-static features found in the security-related inputs. The edges represent relationships between the nodes. A trigger node, which serves as an initial trigger for a given cyber-security investigation, is selected in the graph. An iterative process, which generates a sub-graph of the graph that is specific to the given cyber-security investigation, is performed by iteratively (i) enriching the graph with additional information and (ii) expanding the sub-graph with one or more additional nodes from the graph in information. A decision is response to the additional made on a result of the given cyber-security investigation based on the sub-graph.

There is also provided, in accordance with an embodiment of the present invention, a computer software product. The product includes a tangible non-transitory computer-readable medium in which program instructions are stored, which instructions, when read by one or more processors, cause the one or more processors to: receive security-related inputs detected in a computer system; construct, based on the security-related inputs, a graph comprising nodes and edges, the nodes including (i) one or more appearance-nodes representing occurrences in the computer system having respective times-of-occurrence and (ii) one or more artifact-nodes representing time-static features found in the security-related inputs, and the edges representing relationships between the nodes;

select in the graph a trigger node that serves as an initial trigger for a given cyber-security investigation; perform an iterative process that generates a sub-graph of the graph that is specific to the given cyber-security investigation, by iteratively (i) enriching the graph with additional information and (ii) expanding the sub-graph with one or more additional nodes from the graph in response to the additional information; and decide on a result of the given cyber-security investigation based on the sub-graph.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for autonomous cyber-security investigation, in accordance with an embodiment of the present invention;

FIG. 2 is a diagram illustrating an artifacts and appearances graph used by the system of FIG. 1, in accordance with an embodiment of the present invention;

FIG. 3 is a diagram illustrating examples of file appearance nodes, in accordance with embodiments of the present invention; and

FIG. 4 is a flow chart that schematically autonomous cyber-security illustrates a method for investigation, in accordance with an embodiment of the present invention.

### DETAILED DESCRIPTION OF EMBODIMENTS

### Overview

Embodiments of the present invention that are described herein provide methods and systems for autonomous cyber-security investigation. In some embodiments, an investigation system ingests large volumes of security-related inputs, e.g., events, alerts and incidents, obtained a computer system being protected. The investigation system conducts cyber-security investigations autonomously, including analyzing the significance of the inputs and their mutual relationships, autonomously reaching a verdict and initiating suitable responsive actions.

A central component of the disclosed techniques is a data structure referred to as an “artifacts and appearances graph”, or simply “graph” for brevity. The graph is constructed, enriched and continually maintained by the investigation system based on the received security-related inputs.

The graph comprises two types of nodes, referred to as “artifact nodes” and “appearance nodes”. The artifact nodes represent time-static features that are found in the security-related inputs, e.g., hash values, file paths, domain names or Internet Protocol (IP) addresses. The appearance nodes represent occurrences in the computer system that have specific times of occurrence, e.g., a process instance, a network transaction or a file being opened or modified.

The investigation system typically assigns each node a respective “relevance score” that quantifies the relevance of the node to subsequent investigations. For example, the relevance score of an appearance node may depend on the time that elapsed since the time of occurrence associated with the node (since recent occurrences are typically more relevant than old ones). As another example, the relevance score of an artifact node may depend on factors such as prevalence (since rare occurrences tend to be more relevant than common ones) and external Threat Intelligence (TI) information.

The prevalence being considered may be local prevalence (within the specific computer system being protected), global prevalence (evaluated over multiple computer systems shared by investigation system 20), or a combination of both. The term “computer system” is also referred to as a “tenant”. In this context, the term “local prevalence” typically refers to the number of unique agents in the tenant in which the event occurs. The term “global prevalence” typically refers to global number of unique tenants in which the event occurs across multiple tenants, e. g., all tenants handled by investigation system 20.

In addition to the two types of nodes, the graph comprises edges representing relationships between nodes. For example, an appearance node may be connected to an artifact node by an edge representing a “resource_of” relationship, indicating that the artifact is a resource used to describe the appearance. As another example, a process appearance node may be connected to a file appearance node by a “causality_actor_of” or “actor_of” edge, indicating that the file event was performed by the process (actor) or by the causality owned by the process (causality actor). The term “causality” means the root of the process tree of the process associated with the process appearance node.

The initial construction of the graph typically involves deciding which security-related inputs to ingest, normalizing the various types of security-related inputs to a common format, and populating the graph with suitable nodes and edges.

The graph described above is generic, i.e., not specific to any particular cyber-security investigation. To perform a given investigation using the graph, the investigation system generates a sub-graph that is relevant to that investigation. Generation of the sub-graph begins by choosing a “trigger node” and one or more “cut-off distances”. The trigger node will serve as the starting point of the investigation. One type of cut-off distance, referred to as “max_path_score”, is the maximal distance, from the trigger node, of nodes that should be included in the sub-graph. The max_path_score distance between two nodes in the graph is typically defined as the sum of the relevance scores of the nodes along the shortest path between the two nodes. Another type of cut-off distance, referred to as “max_nodes_from_src_node”, is the maximal permitted number of nodes (along the shortest path) from the trigger node to a node that should be included in the sub-graph. In some embodiments the system uses both types of cut-off distance, i.e., includes in the sub-graph only nodes that are closer to the trigger node than both cut-off distances. The system may identify the set of nodes, whose distances from the trigger node are below the cut-off distance, by using a modification of the well-known Dijkstra algorithm. The algorithm was published by Dijkstra, in “A Note on Two Problems in Connexion with Graphs,” Numerische Mathematik 1, (1959), pages 269-271.

Having set the trigger node the cut-off distance, the investigation system performs an iterative process that generates the sub-graph. In this process, the investigation system iteratively (i) enriches the graph with additional information and (ii) expands the sub-graph with one or more additional nodes from the graph in response to the additional information. The iterative process terminates when no additional nodes can be added to the sub-graph.

The investigation system then decides on a result of the investigation (referred to as “verdict”) based on the sub-graph. The verdict may be, for example, True Positive (TP), False Positive (FP), “Inconclusive” or “Unsupported”. The investigation system initiates a responsive action depending on the verdict. For example, a TP verdict typically triggers remedial action such as isolating relevant parts of the computer system and alerting an operator. A FP verdict typically causes the investigation system to close the investigation without further action. When the verdict is “Inconclusive” or “Unsupported”, the investigation system may transfer the investigation to a human operator for further consideration.

The methods and systems described herein are highly effective in autonomously investigating and reacting to security-related inputs. As such, the disclosed techniques can protect computer systems in real-time with high accuracy and low cost, in comparison with human investigators.

### System Description

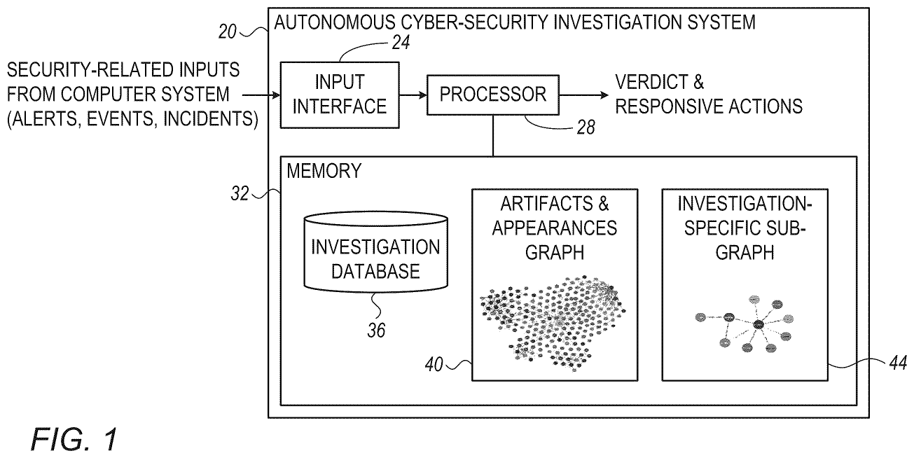

FIG. 1 is a block diagram that schematically illustrates a system 20 for autonomous cyber-security investigation, in accordance with an embodiment of the invention. System 20 is assigned to protect a present computer system (not seen in the figure) against malicious attacks, and in particular to conduct cyber-security investigations.

In the embodiment of FIG. 1, investigation system 20 comprises an input interface 24, one or more processors 28 and a memory 32. The description that follows refers to a single processor 28, for clarity.

Input interface 24 receives various security-related inputs from the computer system being protected. The security-related inputs may comprise any suitable type of inputs that may be relevant to cyber-security, e.g., various events, alerts and/or incidents occurring in the computer system. An event may comprise, for example, a process creation event and the relevant information describing it. An alert may comprise, for example, “Local Analysis Malware” and the relevant events associated with the alert. An incident may comprise, for example, a grouped list of related alerts. In an example that demonstrates the differences between events, alerts and incidents, an event may indicate that “Process X executed Process Y”; an alert may indicate that “Process Y which is malicious was executed”; whereas an incident may comprise one or more high-severity alerts.

Processor 28 uses the security-related inputs to autonomously conduct cyber-security investigations, using methods that are described below. Upon completing an investigation, processor 28 output a verdict and suitable responsive actions. In conducting the investigations, processor 28 maintains several data structures in memory 32, namely an investigation database 36, an artifacts and appearances graph 40 and an investigation-specific sub-graph 44 per investigation. The structure and usage of these data structures are explained in detail below.

The configuration of system 20 shown in FIG. 1 is an example configuration, which is chosen purely for the sake of conceptual clarity. In alternative embodiments, any other suitable configuration can be used. For example, the tasks of processor 28 may be split among multiple processors. Elements that are not necessary for understanding the principles of the present invention have been omitted from the figures for clarity.

The various elements of system 20 may be implemented in hardware, e.g., in one or more Application-Specific Integrated Circuits (ASICs) or FPGAs, in software, or using a combination of hardware and software elements. Memory 32 may comprise any suitable type of memory, e.g., Random-Access Memory (RAM) or disk.

Processors 28 may comprise one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

### Autonomous Investigation Using Graphs

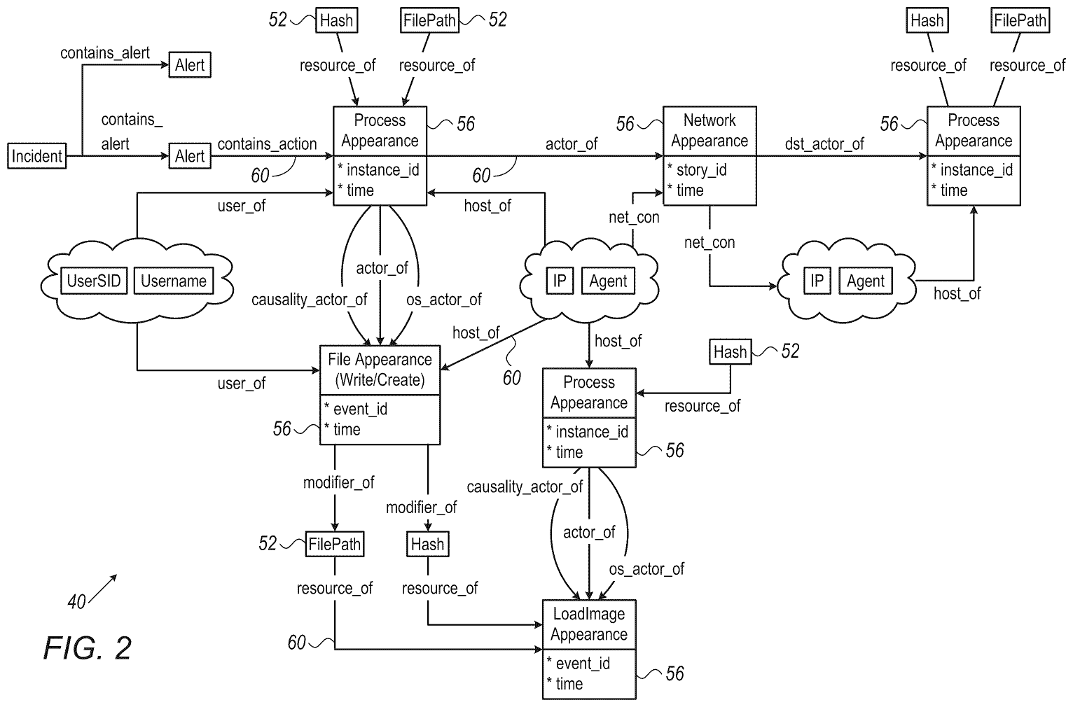

FIG. 2 is a diagram illustrating an example of artifacts and appearances graph 40 used by processor 28, in accordance with an embodiment of the present invention. Graph 40 is constructed by processor 28 based on the security-related inputs received from the computer system. Processor 28 typically updates graph 40 on an ongoing basis as new security-related inputs arrive. Graph 40 is generic, in the sense that it is not specific to any particular investigation.

Graph 40 comprises two types of nodes, referred to as “artifact nodes” 52 and “appearance nodes” 56. Each artifact node 52 represents a time-static feature that is found in the security-related inputs. As seen in the figure, examples of artifact nodes 52 include hash values (e.g., SHA256), domain names and IP file paths, addresses. The nodes labeled “UserSID”, “Username” and “Agent” are also artifact nodes. Each appearance node 56 represents an occurrence in the computer system that has a specific time-of-occurrence. Examples of appearance nodes 56 include appearance of a process, of a network transaction, a file or loading of an image. An individual event, alert or incident can also be represented by an appearance node 56. Each appearance node comprises a unique identifier (ID) and the associated time-of-occurrence.

Graph 40 further comprises edges 60, which represent relationships between nodes. System 20 supports multiple types of edges 60, representing multiple types of relationships between nodes. Example types that are seen in FIG. 2 include the following:
“resource_of”—An edge connecting an artifact to an appearance, indicating that the artifact was a resource in the creation of the appearance.
“actor_of”—An edge connecting a process appearance to another appearance (of any type), indicating that the process was the one to perform the second appearance (at a logical level).
“causality_actor_of”—An edge connecting a process appearance to another appearance (of any type), indicating that a process in the causality process tree owned by the process from the appearance was the one to perform the second appearance (at a logical level).
“os_actor_of”—An edge connecting process appearance to another appearance (of any type), indicating that the process was the one to perform the second appearance (at the operating system level).
“dst_actor_of”—An edge connecting a network appearance to a process appearance, indicating that the process was the receiver of the network connection.
“host_of”—An edge connecting an artifact to an appearance, indicating that the appearance was performed on the host described by the artifact.
“user_of”—An edge connecting an artifact to an appearance, indicating that the appearance was performed by the user described by the artifact.
“modifier_of”—An edge connecting an appearance to an artifact, indicating that the appearance modified the artifact. The artifact is the result of the modification.
“contains_alert”—An edge connecting an incident to an alert, indicating that the alert is associated with the incident.
“contains_action”—An edge connecting an alert to an appearance, indicating that the appearance is associated with the alert.
“net_con”—An edge connecting a network appearance to an artifact (or vice versa), to describe a network connection. The direction of the edge matches the direction of the connection.

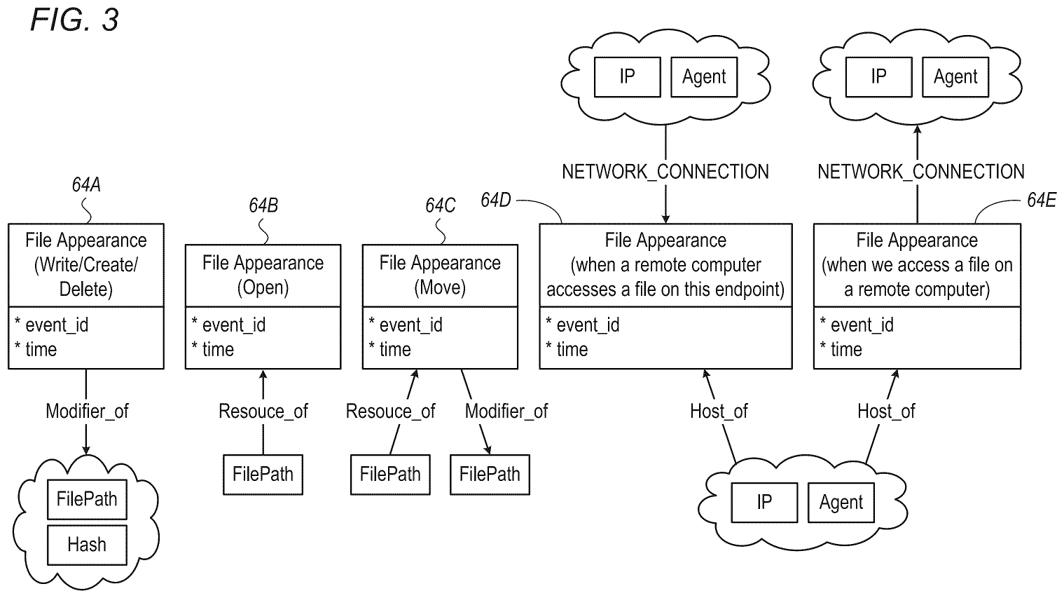

Additionally or alternatively, any other suitable type of edge can be used. The direction of the edge represents the logical cause-and-effect relationship between the two nodes. FIG. 3 is a diagram illustrating examples of file appearance nodes 64A-64E and their possible relationships with artifact nodes, in accordance with embodiments of the present invention.

Node 64A represents a detected write, create or delete operation of a certain file. Node 64A is identified uniquely by an event_id, and also comprises the time-of-occurrence of the write, create or delete operation. Node 64A is connected by an edge of type “modifier_of” to a pair of artifact nodes representing the path of the file and a hash value associated with the file.

Node 64B represents a detected operation of opening a certain file. Node 64B is identified uniquely by an event_id, and also comprises the time-of-occurrence of the file opening operation. An artifact node representing the path of the file is connected to node 64B by an edge of type “resource_of”.

Node 64C represents a detected operation of moving a certain file to another location (and thus a different path). Node 64C is uniquely identified by an event_id, and also comprises the time-of-occurrence of the move operation. Node 64C is connected by an edge of type “resource_of” to an artifact node representing the previous path, and by an edge of type “modifier_of” to an artifact node representing the new path.

Node 64D represents a detected operation of accessing a certain file on a monitored endpoint by a remote computer. Node 64E represents a detected operation of accessing a certain file on a remote computer by a monitored endpoint. Each of nodes 64D and 64E is connected by an edge of type “network_connection” to a pair of “IP” and “Agent” artifact nodes representing the IP address and Agent ID of the connection. Each of nodes 64D and 64E is also connected by an edge of type “host_of” to a pair of artifact nodes representing the IP address and Agent ID in which the file event was generated.

The node and edge configurations shown in FIG. 3 are example configurations that are chosen purely for the sake of conceptual clarity. In alternative embodiments, any other suitable configuration can be used.

### Autonomous Investigation Using Graphs

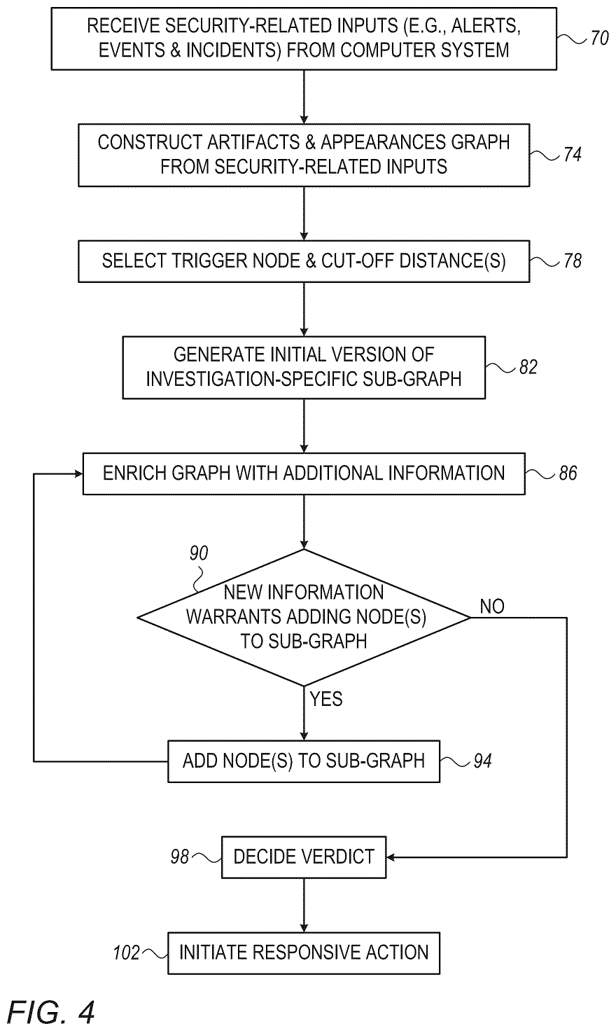

FIG. 4 is a flow chart that schematically illustrates a method for autonomous cyber-security investigation, in accordance with an embodiment of the present invention. In some embodiments, the method is carried out by investigation system 20 of FIG. 1 above.

The method begins with input interface 24 of system 20 receiving security-related inputs (e.g., events, alerts and/or incidents) from the computer system being protected, at an input stage 70. The security-related inputs are transferred to processor 28 and/or stored in database 36.

In practice, the security-related inputs often originate from various different sources in the computer system. To facilitate subsequent processing, in some embodiments processor 28 normalizes the various inputs to a common format. In one non-limiting example, each input is converted to a format matching a row in Google BigQuery. In some embodiments, as another preparatory step, processor 28 decomposes complex inputs into more basic inputs, e.g., extracts low-level events from alerts and/or extracts alerts from incidents. The logic of this decomposition typically differs from one type of security-related input to another. The decomposed inputs are typically saved in database 36.

At a graph population stage 74, processor 28 constructs graph 40 from the various security-related inputs. In some embodiments, processor 28 ingests all security-related inputs and converts them into artifact nodes 52, appearance nodes 56 and edges 60. In other embodiments, processor 28 filters the security-related inputs using a certain criterion before ingestion, i.e., constructs graph 40 from only a selected subset of the security-related inputs. In an example implementation, processor 28 ingests only (i) incidents, (ii) alerts associated with the incidents, and (iii) events contained in these alerts. In other words, standalone alerts and events, which are not part of any composite incident, are omitted from graph 40 in this embodiment.

Up to this point, the method is generic and preparatory. The stages that follow are performed for carrying out a specific investigation. Stages 82-102 below are typically repeated per investigation.

To perform a given investigation, processor 28 generates an investigation-specific subgraph of graph 40, e.g., sub-graph 44 of FIG. 1. The construction of the sub-graph aims to (i) contain information that is relevant to the specific investigation, and (ii) contain heavily enriched information, provided the information is relevant.

At a sub-graph initialization stage 82, processor 28 generates an initial version of sub-graph 44. Processor 28 begins the initial generation by choosing a “trigger node” and setting “max_path_score” and “max_nodes_from_src_node” “cut-off distances” for the sub-graph. The selected trigger node serves as the starting point of the investigation. In some embodiments, the trigger node may comprise any node in graph 40. In other embodiments, certain restrictions may be imposed on the selection of the trigger node. For example, processor 28 may restrict the selection to a node representing an incident, or an alert included in an incident.

The “max_path_score” and “max_nodes_from_src_node” cut-off distances are the maximal distances (in terms of relevance scores and number of nodes as explained above), from the trigger node, of nodes in graph 40 that will be imported into sub-graph 44. In an example implementation, for each type of cut-off distance, processor 28 uses a modification of the Dijkstra algorithm to identify the set of nodes (52 and 56) in graph 40 that are distant from the trigger node by no more than the cut-off distance. To be added to sub-graph, a node needs to be closer to the trigger node than both cut-off distances. In other embodiments, any other suitable algorithm can be used.

Having generated the initial version of investigation-specific sub-graph 44, processor 28 now performs an iterative process (stages 86-94 below) that alternates between enrichment t iterations and expansion iterations. An enrichment iteration enriches graph 40 and sub-graph 44 with additional information. An expansion iteration expands sub-graph 44 with one or more additional nodes from graph 40 in response to the additional information.

At an enrichment stage 86, processor 28 fetches additional information that will enrich graph 40 and sub-graph 44 in relation to the investigation being conducted. The enrichment may result in, for example, addition of new nodes, addition of attributes to existing nodes, addition of new edges, and/or addition of attributes to existing edges.

In some enrichment actions, processor 28 fetches information from the computer system being protected. In other enrichment actions, processor 28 fetches information from other sources, e.g., Threat Intelligence (TI) or global information obtained from other computer systems being protected by investigation system 20. Several non-limiting examples of enrichment actions, which may be performed by processor 28, include the following:
Enriching artifact nodes with information about their prevalence in the specific computer system (local prevalence) and/or their prevalence across multiple computer systems (global prevalence).
Querying raw events logged in the computer system.
Querying alerts table of computer system.
Querying a TI system.
Getting a file from the computer system.
Dumping a memory region from a computer (server or endpoint) in the computer system.
Running a script on a security agent in the computer system.
Any other suitable action.

In various embodiments, processor 28 may use any suitable method for deciding what additional relevant information needs to be fetched, under which conditions, for which nodes, from which information source, etc.

In some embodiments, processor 28 holds a bank of “enrichment rules” for making enrichment decisions. For example, an enrichment rule may specify that for each Process Appearance in the investigation subgraph, processor 28 is to fetch all other image loads of any unsigned modules that occurred in a specific period of time before or after the occurrence of the investigated events.

Other enrichment rules are more specific, in the sense that they are relevant to specific investigation types or use cases. An example of such a rule is: If there is a ransomware alert in the subgraph, enrich the sub-graph with all file writes occurring in a specified time frame. This logic can be generic, or specific for specific use cases.

As another example, enrichment rules may depend on the relevance scores of the nodes. For example, in some embodiments processor 28 may enrich only nodes whose relevance scores are below some defined threshold. Additionally, or alternatively, any other suitable enrichment rules can be used.

Typically, the additional information obtained by the enrichment actions is not immediately added to sub-graph 44, but initially added only in database 36. The subsequent expansion iteration will check whether (and which parts of) the new information should be added to sub-graph 44.

Following the enrichment iteration of stage 86, processor 28 checks whether the enrichment warrants addition of any additional nodes from graph 40 to sub-graph 44, at an expansion checking stage 90. Typically, processor 28 performs this stage by checking whether graph 40 contains any node that (i) is not currently part of sub-graph 44 and (ii) is closer to the trigger node than the cut-off distance. If one or more such nodes are found, processor 28 adds them to sub-graph 44, at an expansion stage 94. The method then loops back to stage 86 above for performing the next enrichment iteration.

If, on the other hand, expansion checking stage 90 concludes that no additional nodes can be added to sub-graph 44, the iterative enrichment-expansion process is terminated and sub-graph 44 is considered ready.

Processor 28 then uses sub-graph 44 to decide on the result of the investigation, at a verdict decision stage 98. In an embodiment, processor 28 runs multiple “attack detection modules”. Each attack detection module accepts sub-graph 44 as input, and decides whether the sub-graph is indicative of a specific type of malicious attack. Examples of attack detection modules are a module that detects a phishing attack, a module that detects a lateral movements attack, a module that detects a ransomware attack, etc.

In various embodiments, processor 28 may use any suitable method for deciding on a verdict based on a given sub-graph. In an example embodiment, an attack detection module can enrich a subgraph in accordance with specific module-related questions, and if an artifact in the subgraph has a very low score, the module concludes maliciousness.

In another embodiment, an attack detection module asks various questions related to the module, and scores the answer based on weights that are configured by the module. For example, in a ransomware attack detection module, if the module finds a ransom note with a specific extension, the module increases a maliciousness score of the sub-graph. If the module finds such a node in every folder, the module scores the sub-graph with a value signifying that the sub-graph indicates a malicious attack.

Another example relates to a phishing attack detection module. For each node in the sub-graph whose relevance score is below a defined threshold, the module uses the following features to calculate a maliciousness score for the sub-graph:
The relevance score.
The module checks all the possible “origins” of the nodes in the sub-graph, by backtracking all the edges that are directed to the chosen node (i.e., following the arrows in the reverse direction). The module continues this process until no additional backtracking is possible (i.e., until reaching a node that does not have any edges pointing to it). The module then checks whether any of the origin nodes are known email clients, browsers, office processes, etc. Using this logic, the module calculates a normalized maliciousness score over the phishing-related alerts in any of the origin nodes.

Alternatively, any other suitable method can be used.

In some embodiments, the verdicts output by the attack detection have four possible values:
True Positive (TP)—A malicious attack is detected.
False Positive (FP)—No malicious attack detected.
Inconclusive—Cannot decide whether an attack occurs or not.
Unsupported.

Alternatively, other suitable verdicts can be used. For example, the verdict may specify the type of attack, its severity, the part of the computer system being affected by the attack, recommendations for future actions by a human, etc.

At a responding stage 102, processor 28 initiates suitable responsive actions depending on the verdict. A large variety of actions can be initiated. For example, in response to a TP verdict, processor 28 typically triggers remedial action such as isolating relevant parts of the computer system, killing affected processes, quarantining affected files, disabling affected users, etc. In response to a FP verdict, processor 28 typically closes the investigation without further action other than logging. When the verdict is “Inconclusive” or “Unsupported”, processor 28 may transfer the investigation to a human operator for further consideration. In alternative embodiments, any other suitable actions can be taken.

When responding to a TP verdict, processor 28 may decide which remedial action to initiate based on the characteristics of the detected attack. For example, if the sub-graph indicates a malicious hash value, processor 28 may decide to block this hash. If the sub-graph indicates a malicious process (e. g., causality), processor 28 may decide to kill that process and any dependent processes it may have. If the sub-graph indicates a malicious domain, processor 28 may decide to block the domain. Importantly, many remedial actions can be taken automatically without human intervention, thereby enabling system 20 to react rapidly to true-positive attack detections.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system for autonomous cyber-security investigation, the system comprising:
an input interface, configured to receive security-related inputs detected in a computer system; and
one or more processors, configured to:
construct, based on the security-related inputs, a graph comprising nodes and edges, the nodes comprising (i) one or more appearance-nodes representing occurrences in the computer system having respective times-of-occurrence and (ii) one or more artifact-nodes representing time-static features found in the security-related inputs, and the edges representing relationships between the nodes;
select in the graph a trigger node that serves as an initial trigger for a given cyber-security investigation;
perform an iterative process that generates a sub-graph of the graph that is specific to the given cyber-security investigation, by iteratively (i) enriching the graph with additional information and (ii) expanding the sub-graph with one or more additional nodes from the graph in response to the additional information; and
decide on a result of the given cyber-security investigation based on the sub-graph.

2. The system according to claim 1, wherein the one or more processors are further configured to initiate a responsive action based on the result of the given cyber-security investigation.

3. The system according to claim 1, wherein the one or more processors are configured to enrich the graph by fetching at least part of the additional information from the computer system.

4. The system according to claim 1, wherein the one or more processors are configured to iteratively expand the sub-graph, starting from the trigger node, until failing to find additional nodes whose distance from the trigger node is below one or more defined cut-off distances.

5. The system according to claim 4, wherein the one or more processors are configured to:
assign respective significance scores to the nodes; and
calculate the distance between a candidate node and the trigger node responsively to the relevance scores of one or more nodes that lie along a shortest path through the graph between the candidate node and the trigger node.

6. The system according to claim 1, wherein the one or more processors are configured to enrich the graph in accordance with a predefined bank of enrichment rules.

7. The system according to claim 1, wherein the one or more processors are configured to decide on the result of the given cyber-security investigation by running multiple attack detection modules, each attack detection module associated with a respective type of malicious attack.

8. The system according to claim 7, wherein a given attack detection module is configured to calculate for the sub-graph a maliciousness score indicative of a likelihood that the sub-graph represents a malicious attack of the respective type.

9. A method for autonomous cyber-security investigation, the method comprising:
receiving security-related inputs detected in a computer system;
constructing, based on the security-related inputs, a graph comprising nodes and edges, the nodes comprising (i) one or more appearance-nodes representing occurrences in the computer system having respective times-of-occurrence and (ii) one or more artifact-nodes representing time-static features found in the security-related inputs, and the edges representing relationships between the nodes;
selecting in the graph a trigger node that serves as an initial trigger for a given cyber-security investigation;
performing an iterative process that generates a sub-graph of the graph that is specific to the given cyber-security investigation, by iteratively (i) enriching the graph with additional information and (ii) expanding the sub-graph with one or more additional nodes from the graph in response to the additional information; and
deciding on a result of the given cyber-security investigation based on the sub-graph.

10. The method according to claim 9, further comprising initiating a responsive action based on the result of the given cyber-security investigation.

11. The method according to claim 9, wherein enriching the graph comprises fetching at least part of the additional information from the computer system.

12. The method according to claim 9, wherein performing the iterative process comprises iteratively expanding the sub-graph, starting from the trigger node, until failing to find additional nodes whose distance from the trigger node is below one or more defined cut-off distances.

13. The method according to claim 12, further comprising:
assigning respective significance scores to the nodes; and
calculating the distance between a candidate node and the trigger node responsively to the relevance scores of one or more nodes that lie along a shortest path through the graph between the candidate node and the trigger node.

14. The method according to claim 9, wherein enriching the graph comprises applying a predefined bank of enrichment rules.

15. The method according to claim 9, wherein deciding on the result of the given cyber-security investigation comprises running multiple attack detection modules, each attack detection module associated with a respective type of malicious attack.

16. The method according to claim 15, wherein running the attack detection modules comprises, in a given attack detection module, calculating for the sub-graph a maliciousness score indicative of a likelihood that the sub-graph represents a malicious attack of the respective type.

17. A computer software product, the product comprising a tangible non-transitory computer-readable medium in which program instructions are stored, which instructions, when read by one or more processors, cause the one or more processors to:
receive security-related inputs detected in a computer system;
construct, based on the security-related inputs, a graph comprising nodes and edges, the nodes comprising (i) one or more appearance-nodes representing occurrences in the computer system having respective times-of-occurrence and (ii) one or more artifact-nodes representing time-static features found in the security-related inputs, and the edges representing relationships between the nodes;
select in the graph a trigger node that serves as an initial trigger for a given cyber-security investigation;
perform an iterative process that generates a sub-graph of the graph that is specific to the given cyber-security investigation, by iteratively (i) enriching the graph with additional information and (ii) expanding the sub-graph with one or more additional nodes from the graph in response to the additional information; and
decide on a result of the given cyber-security investigation based on the sub-graph.

18. The product according to claim 17, wherein the instructions cause the one or more processors to enrich the graph by fetching at least part of the additional information from the computer system.

19. The system according to claim 17, wherein the instructions cause the one or more processors to iteratively expand the sub-graph, starting from the trigger node, until failing to find additional nodes whose distance from the trigger node is below one or more defined cut-off distances.

20. The system according to claim 17, wherein the instructions cause the one or more processors to decide on the result of the given cyber-security investigation by running multiple attack detection modules, each attack detection module associated with a respective type of malicious attack.
